(19) United States
(12) Patent Application Publication
(10) Pub. No.: US 2006/0044249 A1
(43) Pub. Date: Mar. 2, 2006

(54) Display apparatus

(76) Inventors: Seung-Woo Lee, Seoul (KR); Moon-Shik Kang, Seongnam-si (KR); Min-Hong Kim, Seoul (KR)

Correspondence Address: CANTOR COLBURN, LLP, 55 GRIFFIN ROAD SOUTH, BLOOMFIELD, CT, 06002, US

(21) Appl. No.: 11/185,508

(22) Filed: Jul. 20, 2005

(30) Foreign Application Priority Data
Aug. 31, 2004 (KR) 2004-68813

(51) Int. Cl. G09G 3/36

(52) U.S. Cl. 345/98

(57) ABSTRACT

In a display apparatus, a display part displays images in response to driving signals, and a driving part outputs the driving signals to the display part in response to control signals. A control part includes circuits outputting the control signals to the driving part. Circuits of the control part are connected to an interface for a data communication between the circuits. Thus, the circuits may generate flexible data because the master electrically connected to the digital interface controls the circuits.

This application relies for priority upon Korean Patent Application No. 2004-68813 filed on Aug. 31, 2004, the contents of which are herein incorporated by reference in its entirety.

### BACKGROUND OF THE INVENTION

1. Field of the Invention

The present invention relates to a display apparatus. More particularly, the present invention relates to a display apparatus having improved productivity.

2. Description of the Related Art

In general, a liquid crystal display apparatus includes a liquid crystal display panel that displays images in response to a data signal and a gate signal, a data driver that outputs the data signal and a gate driver that outputs the gate signal. The liquid crystal display apparatus further includes a timing controller, a nonvolatile memory and a DC-DC converter to drive the data driver and the gate driver.

The timing controller receives image data and various external control signals and applies inner control signals to the data driver and the gate driver. The DC-DC converter changes a power voltage externally provided into a driving voltage to drive the data driver and the gate driver.

The liquid crystal display apparatus further includes a common voltage generator applying a common voltage to the liquid crystal display panel and a gamma voltage generator applying a gamma voltage to the data driver.

Parts, such as the timing controller, the nonvolatile memory, the DC-DC converter, the common voltage generator and the gamma voltage generator, are manufactured responsive to desired specifications of the liquid crystal display panel.

Thus, when a specification of the liquid crystal display panel is varied, individual parts of the liquid crystal display panel must be varied accordingly. As a result, productivity of the liquid crystal display panel is lowered.

### BRIEF SUMMARY OF THE INVENTION

An exemplary embodiment of the present invention provides a display apparatus having improved productivity.

In one aspect of the present invention, a display apparatus includes a display part to display images in response to driving signals, a driving part to output the driving signals to the display part in response to control signals, a control part having circuits to output the control signals to the driving part, and an interface electrically connected between the circuits of the control part to communicate data between the circuits.

In another aspect of the present invention, a display apparatus includes a display panel, a data driving circuit, a gate driving circuit, a common voltage generating circuit, a gamma voltage circuit, a timing control circuit and an interface.

The display panel has a data line receiving a data signal and a gate line receiving a gate signal and displays images in response to the data signal and the gate signal. The data driving circuit outputs the data signal to the data line in response to an image data and a data control signal, and the gate driving circuit outputs the gate signal to the gate line in response to a gate control signal.

The common voltage generating circuit adjusts a voltage level of a common voltage and applies the common voltage to the display panel in response to a first digital control signal. The gamma voltage generating circuit converts a gamma data into a gamma voltage in an analog form and applies the gamma voltage to the data driving circuit. The timing control circuit, responsive to an external signal, applies the gate control signal to the gate driving circuit, applies the image data and the data control signal to the data driving circuit and outputs the first digital control signal and the gamma data. The interface is electrically connected to the common voltage generating circuit, the gamma voltage generating circuit and the timing control circuit to communicate data between the common voltage generating circuit, the gamma voltage generating circuit and the timing control circuit.

According to the above, the circuits of the controller are electrically connected to the digital interface for the data communication, so that the circuits may generate flexible data because the master electrically connected to the digital interface controls the circuits.

### BRIEF DESCRIPTION OF THE DRAWINGS

The above and other advantages of the present invention will become readily apparent by reference to the following detailed description when considered in conjunction with the accompanying drawings wherein:

FIG. 1 is a block diagram showing a liquid crystal display apparatus according to an exemplary embodiment of the present invention;

FIG. 2 is a block diagram showing a controller of the liquid crystal display apparatus shown in FIG. 1;

FIG. 3 illustrates waveform diagrams of a serial data line and a serial clock line shown in FIG. 2;

FIG. 4 is a schematic view illustrating a digital serial interface;

FIG. 5 is a schematic view illustrating a digital parallel interface;

FIG. 6 is a block diagram showing a timing control circuit shown in FIG. 1;

FIG. 7 is a block diagram showing a data block shown in FIG. 6;

FIG. 8 is a block diagram showing a common voltage generating circuit of FIG. 1;

FIG. 9 is a block diagram showing a power generating circuit of FIG. 1;

FIG. 10 is a block diagram showing a liquid crystal display apparatus according to another exemplary embodiment of the present invention; and

FIG. 11 is a schematic view showing an inverter control circuit and a brightness sensing circuit of FIG. 10.

### DETAILED DESCRIPTION OF THE INVENTION

Hereinafter, exemplary embodiments of the present invention will be explained in detail with reference to the accompanying drawings.

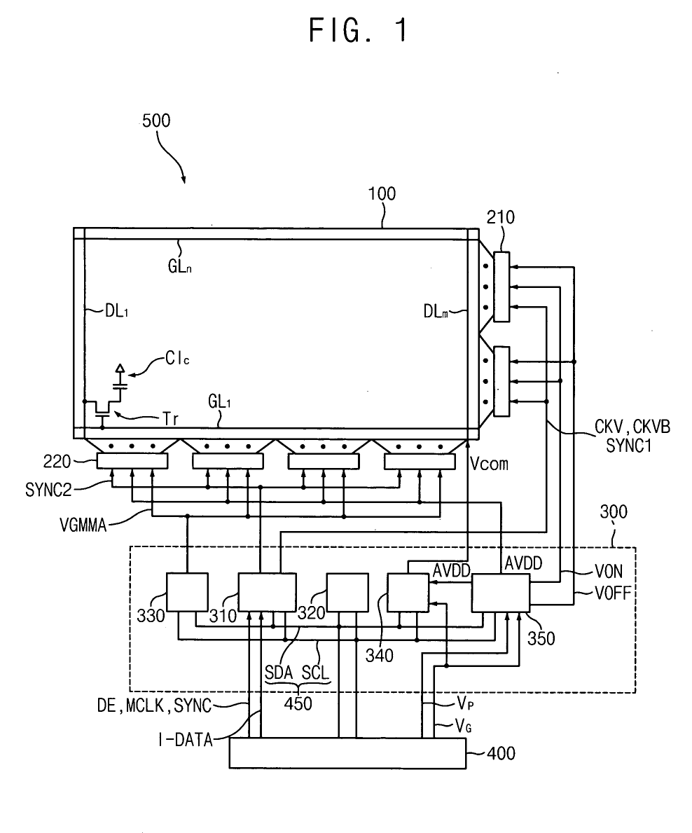

FIG. 1 is a block diagram showing a liquid crystal display apparatus according to an exemplary embodiment of the present invention.

Referring to FIG. 1, a liquid crystal display apparatus 500 includes a liquid crystal display panel 100, a gate driving circuit 210, a data driving circuit 220, a controller 300, an outer interface 400 and an inner interface 450.

The liquid crystal display panel 100 includes gate lines GL1 to GLn (wherein n denotes a positive integer), data lines DL1 to DLm (wherein m denotes a positive integer) crossing the gate lines GL1 to GLn and pixels formed at pixel areas defined by the gate lines GL1 to GLn and the data lines DL1 to DLm. Each of the pixels has a thin film transistor (Tr) and a liquid crystal capacitor (Clc). In a first pixel area, a gate electrode of the thin film transistor (Tr) is electrically connected to a first gate line GL1, a source electrode of the thin film transistor (Tr) is electrically connected to a first data line DL1 and a drain electrode of the thin film transistor (Tr) is electrically connected to a first terminal of the liquid crystal capacitor (Clc).

The gate driving circuit 210 is formed, for example, as an integrated circuit chip and is electrically connected to the gate lines GL1 to GLn. The gate driving circuit 210 sequentially outputs a gate signal to the gate lines GL1 to GLn in response to a first synchronizing signal SYNC1, a first clock CKV, a second clock CKVB, a first driving voltage VON and a second driving voltage VOFF. The data driving circuit 220 is formed, for example, as an integrated circuit chip and is electrically connected to the data lines DL1 to DLm. The data driving circuit 220 outputs a data signal to the data lines DL1 to DLm in response to a second synchronizing signal SYNC2, an analog gamma signal VGAMMA and a third driving voltage AVDD.

The controller 300 is electrically connected to an external device (not shown) via the outer interface 400. The outer interface 400 converts various signals provided from the external device into signals for the liquid crystal display apparatus 500 and provides converted signals to the controller 300. The controller 300 includes a timing control circuit 310, a nonvolatile memory 320, a gamma voltage generating circuit 330, a common voltage generating circuit 340 and a power generating circuit 350.

The inner interface 450 is a serial digital interface. Devices such as the timing control circuit 310, the nonvolatile memory 320, the gamma voltage generating circuit 330, the common voltage generating circuit 340, the power generating circuit 350, etc. communicate with each other via the inner interface 450.

The timing control circuit 310 is formed, for example, as an integrated circuit chip, which receives image data I-DATA and external control signals SYNC, MCLK and DE from the outer interface 400. The timing control circuit 310 stores the image data I-DATA frame by frame into a frame memory (not shown) and reads image data I-DATA that has been stored frame by frame to provide image data I-DATA that has been read to the data driving circuit 220. Additionally, the timing control circuit 310 converts the external control signals SYNC, MCLK and DE into the first and second synchronizing signals SYNC1 and SYNC2, and the first and second clocks CKV and CKVB.

The nonvolatile memory 320 is an electrically erasable and programmable read only memory (EEPROM). The nonvolatile memory 320 stores information such as initial data including, for example, a resolution and a panel size of the liquid crystal display panel 100, which is input via the inner interface 450. The nonvolatile memory 320 stores gamma data having a gray-scale value depending upon average brightness of an image displayed on the liquid crystal display panel 100. When the average brightness of the image is higher than a reference brightness, the gamma data has a gray-scale value higher than a reference gamma. Additionally, when the average brightness of the image is lower than the reference brightness, the gamma data has a gray-scale value lower than the reference gamma.

The timing control circuit 310 applies a gamma synchronizing signal to the gamma voltage generating circuit 330 through the inner interface 450. The gamma voltage generating circuit 330 converts the gamma data stored in a digital form in the nonvolatile memory 320 into a gamma voltage VGMMA in an analog form in response to the gamma synchronizing signal. The gamma voltage VGMMA is outputted by the gamma voltage generating circuit 330 and applied to the data driving circuit 220.

The timing control circuit 310 generates first digital data based on the initial data stored in the nonvolatile memory 320 and provides the first digital data with a first digital data synchronizing signal to the power generating circuit 350 through the inner interface 450. The power generating circuit 350 converts an external power voltage VP into the first driving voltage VON, the second driving voltage VOFF and the third driving voltage AVDD and a logic voltage (not shown) for the liquid crystal display panel 100 in response to the first digital data and the first digital data synchronizing signal. In the present embodiment, the logic voltage drives the common voltage generating circuit 340, the timing control circuit 310 and the gamma voltage generating circuit 330.

The timing control circuit 310 generates second digital data based on the initial data stored in the nonvolatile memory 320 and provides the second digital data with a second digital data synchronizing signal to the common voltage generating circuit 340 through the inner interface 450. The common voltage generating circuit 340 converts the third driving voltage AVDD into a common voltage VCOM for the liquid crystal display panel 100 in response to the second digital data and the second digital data synchronizing signal.

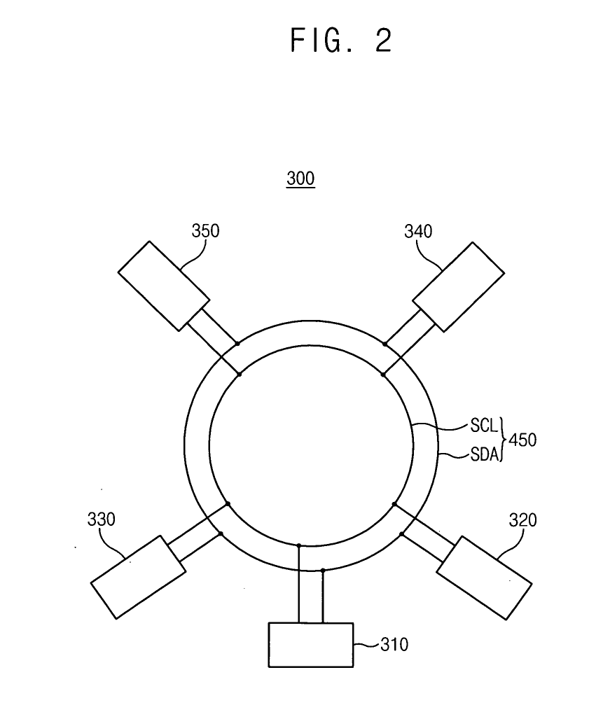

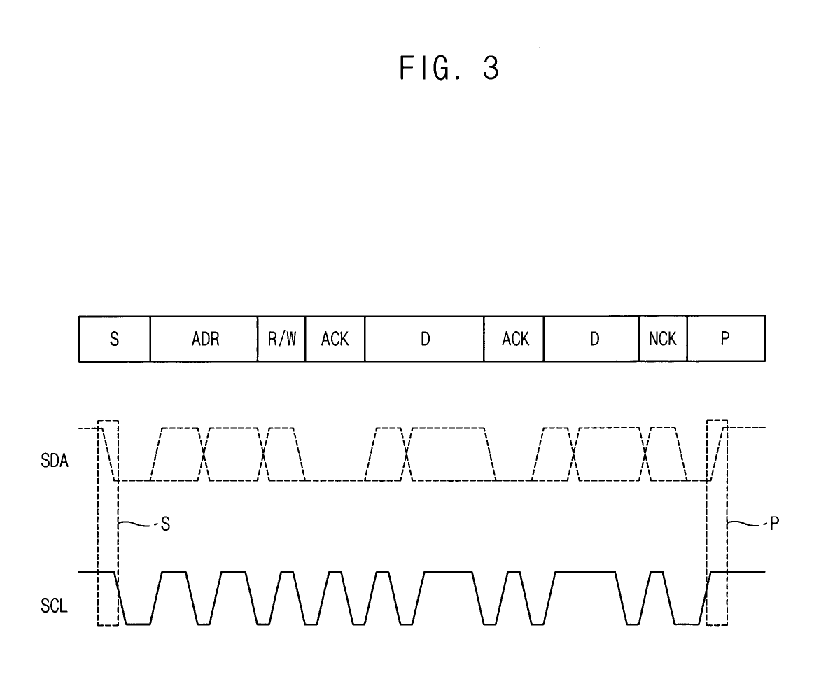

FIG. 2 is a block diagram showing the controller 300 shown in FIG. 1. FIG. 3 illustrates waveform diagrams of a serial data line SDA and a serial clock line SCL shown in FIG. 2.

Referring to FIG. 2, the controller 300 comprises circuits including the timing control circuit 310, the nonvolatile memory 320, the gamma voltage generating circuit 330, the common voltage generating circuit 340 and the power generating circuit 350, and those circuits communicate data between each other through the inner interface 450. The inner interface 450 is a kind of serial digital interface device that may be embodied in, for example, an inter-integrated circuit (commonly referred to as I²C).

The digital interface device is a bidirectional 2-wired interface having the serial data line SDA for data communication and the serial clock line SCL for controlling and synchronizing the data communication between the circuits. Circuits connected to the digital interface device are identified by a specified address so that each of the circuits may transmit or receive data. Data is transmitted between the circuits by a master-slave protocol method. A master starts a data transmission and generates clocks, and a slave transmits data to the master or receives data from the master.

In the controller 300 according to the present invention, the timing control circuit 310 is operated as the master, and the nonvolatile memory 320, the gamma voltage generating circuit 330, the common voltage generating circuit 340 and the power generating circuit 350 are each operated as the slave. The digital interface device may have a multi-master system.

As shown in FIG. 3, a start (S) condition occurs in response to a signal of the serial data line SDA transitioning to a low state from a high state while a signal of the serial clock line SCL is in a high state. After the start (S), the master transmits an address ADR having, for example, seven bits, and then a read/write indicator R/W following the address ADR. The read/write indicator RAN indicates a data transmission direction.

After the address ADR and the read/write indicator R/W are transmitted, the master causes a transition of the serial data line SDA from the low state to the high state. When the slave recognizes the address ADR, the slave pulls down the signal of the digital interface device to transmit an acknowledge signal ACK to the master. In response to the slave failing to recognize the address ADR, the slave transmits a non-acknowledge signal NCK to the master.

When the master receives the acknowledge signal ACK, the master or a corresponding slave transmit the data (D). In response to the data transmission direction being a read (R) direction, the data (D) is transmitted from the corresponding slave to the master. In response to the data transmission direction being a write (W) direction, the data (D) is transmitted from the master to the corresponding slave. When a transmission device, for example, the master or the slave, receives the acknowledge signal ACK, the transmission device transmits additional data (D) to a receiving device, for example, the master or the slave, which receives the data (D).

Processing of the data transmission is repeatedly and continuously performed until the transmission device receives the non-acknowledge signal NCK. In response to the non-acknowledge signal NCK, the master starts or ends the data communication between previously communicating circuits with a start (S) or end (P) condition, respectively. The end (P) condition occurs in response to the signal of the serial data line SDA transitioning to the high state from the low state while the signal of the serial clock line SCL is in the high state.

In FIG. 2, the inner interface 450 having the bidirectional 2-wired interface has been shown, but the inner interface 450 may alternatively be a serial peripheral interface SPI having a 3-wired bus. Although not shown in FIGS. 1 to 3, the serial peripheral interface SPI has a first serial data line for the data transmission, a second serial data line for receiving the data, and a serial clock line for controlling and synchronizing data communication between transmission devices.

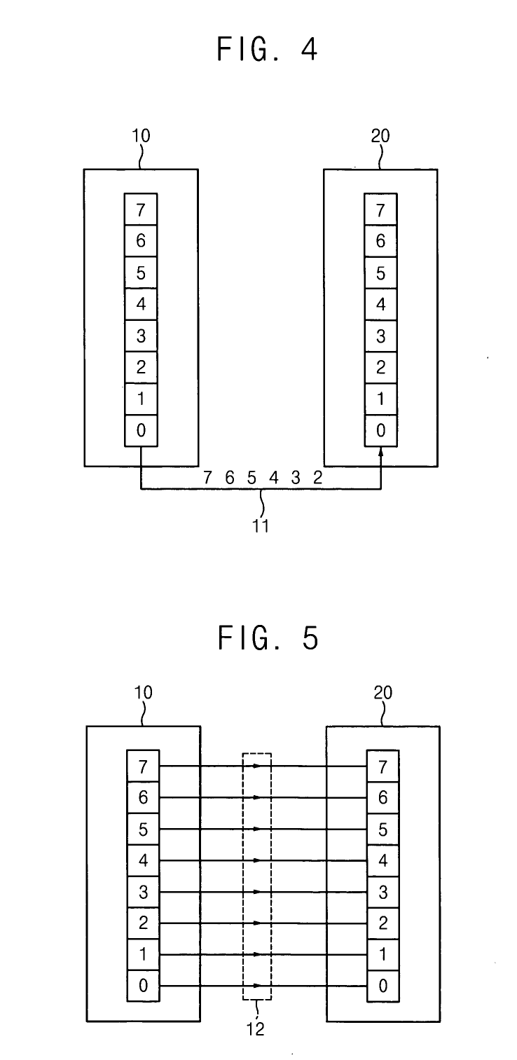

FIG. 4 is a schematic view illustrating a digital serial interface, and FIG. 5 is a schematic view illustrating a digital parallel interface.

Referring to FIGS. 4 and 5, a transmission device 10 transmits the data, and a receiving device 20 receives the data.

In a digital serial interface, the transmission device 10 is connected to the receiving device 20 by only one data line 11. Thus, 8 bit data stored in the transmission device 10 is sequentially transmitted to the receiving device 20 by one bit at a time through the data line 11. In the digital parallel interface, the transmission device 10 is connected to the receiving device 20 by 8 data lines 12. Therefore, the 8 bit data stored in the transmission device 10 is simultaneously transmitted to the receiving device 20 through the 8 data lines.

In FIGS. 1 to 3, the inner interface 450 having the digital serial interface has been described. However, the inner interface 450 may be the digital parallel interface.

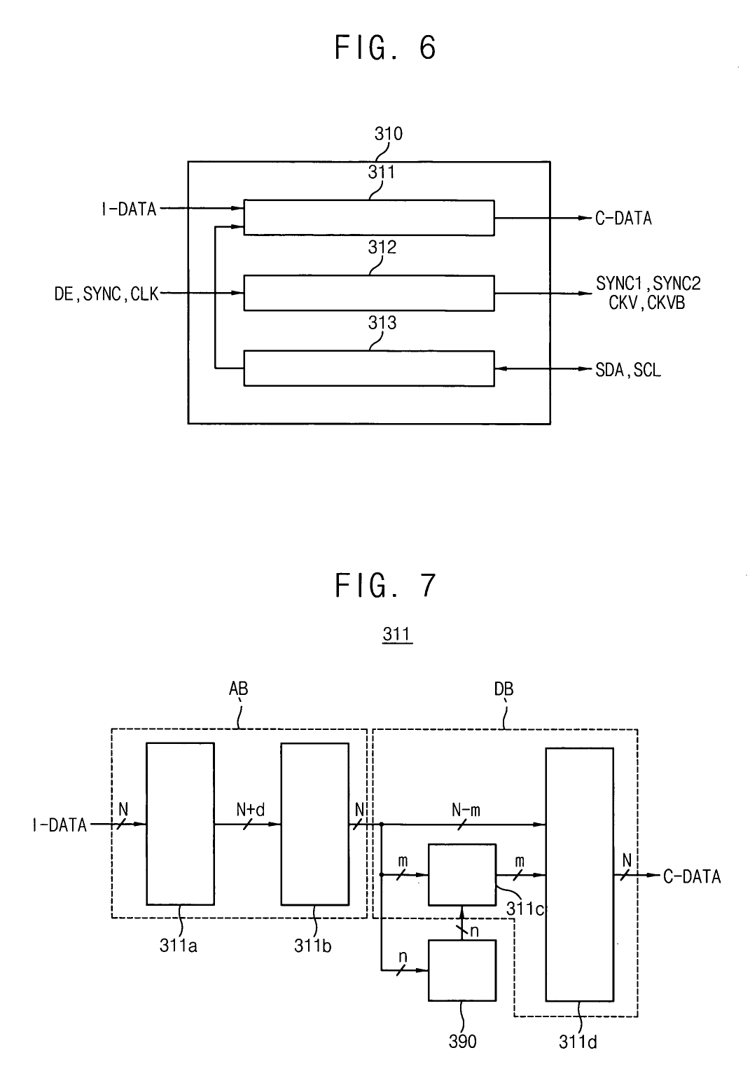

FIG. 6 is a block diagram showing in detail the timing control circuit 310 shown in FIG. 1. FIG. 7 is a block diagram showing in detail a data block shown in FIG. 6.

Referring to FIG. 6, the timing control circuit 310 receives the image data I-DATA, and the external control signals SYNC, MCLK and DE from the outer interface 400 (see FIG. 1). The external control signals SYNC, MCLK and DE include a data enable signal DE, an external synchronizing signal SYNC and a main clock MCLK. The timing control circuit 310 has a data block 311 to process the image data I-DATA and a control signal block 312 to generate the first and second synchronizing signals SYNC1 and SYNC2 and the first and second clocks CKV and CKVB responsive to the data enable signal DE, the external synchronizing signal SYNC and the main clock MCLK.

As shown in FIG. 7, the data block 311 includes an accurate color capture (ACC) block “AB” and a dynamic capacitance compensation (DCC) block “DB”. The ACC block “AB” has a gray-scale expander 311a and a gray-scale compressor 311b, and the DCC block “DB” has a look-up table 311c and a DCC converter 311d.

The ACC block “AB” functions to improve color characteristics of the liquid crystal display apparatus 500 (see FIG. 1). A voltage value applied to a pixel is determined by a numerical value of the image data I-DATA. In other words, image data I-DATA having N bits is expressed by 2^{N} gray-scales. In order to increase a number of the gray-scales, a number of bits of the image data I-DATA must increase. However, an increase in the number of bits of the image data I-DATA causes system complexity to increase. The ACC block “AB” may express at least 2^{N} gray-scales using the image data I-DATA having N bits.

Referring still to FIG. 7, the image data I-DATA having N bits inputted to the ACC block “AB” is expanded to image data having N+d bits by the gray-scale expander 311a. The image data having N+d bits is compressed into the image data I-DATA having N bits to allow the image data of N+d bits to be processed by the data driving circuit 220 (see FIG. 1). The gray-scale compressor 311b compresses the number of the bits of image data I-DATA, and alternately generates two gray-scales A and A+1 that are adjacent to each other as one frame unit. Thus, an average gray-scale (2A+½) with respect to the two gray-scales A and A+1 may be displayed by the liquid crystal display apparatus 500. The average gray-scale may be accurately analyzed in accordance with an expansion of the number of bits of the image data I-DATA. Therefore, when the number of gray-scales is expanded while the image data I-DATA has N bits, color characteristics of the liquid crystal display apparatus 500 are improved.

When the liquid crystal display apparatus 500 expresses a predetermined gray-scale, a time delay occurs since liquid crystal requires a predetermined time to respond. The DCC block “DB” is implemented to reduce the time delay. In response to a gray-scale value (B) of a previous frame being greater than a gray-scale value (B1) of a present frame, the DCC block “DB” converts the gray-scale value (B1) of the present frame into a gray-scale value (B2) greater than the gray-scale value (B1) of the present frame.

For example, the image data I-DATA of N bits outputted from the gray-scale compressor 311b is transmitted to the DCC block “DB”, and upper n-bits (n<N) among N bits of the image data I-DATA are inputted to a frame memory 390. The frame memory 390 stores data corresponding to one frame.

An image data of upper m-bits (m<N) between previous frame data having N bits outputted from the frame memory 390 and present frame data having N bits outputted from the gray-scale compressor 311b are inputted to the look-up table 311c of the DCC block “DB”. The look-up table 311c outputs compensation data of m bits. The compensation data is previously stored in the look-up table 311c responsive to the previous frame data and the present frame data as an address. The outputted compensation data of m bits is provided to the DCC converter 311d. Responsive to the compensation data of m bits, the DCC converter 311d outputs present frame data C-DATA having N bits, thereby improving a response speed of the liquid crystal display apparatus 500.

Referring to FIG. 6, the control signal block 312 generates the first synchronizing signal SYNC1, the second synchronizing signal SYNC2, the first clock CKV and the second clock CKVB using the data enable signal DE, the external synchronizing signal SYNC and the main clock MCLK. The first synchronizing signal SYNC1, the first clock CKV and the second clock CKVB are applied to the gate driving circuit 210, and the second synchronizing signal SYNC2 is applied to the data driving circuit 220.

The timing control circuit 310 further includes an interface block 313. The interface block 313 is electrically connected to the serial data line SDA and the serial clock line SCL of the inner interface 450. The interface block 313 converts data applied through the serial data line SDA into a predetermined signal, and provides the data block 311 or slave circuits of the data block 311 with the predetermined signal. The slave circuits of the data block 311 include, for example, the nonvolatile memory 320, the gamma voltage generating circuit 330, the common voltage generating circuit 340 and the power generating circuit 350.

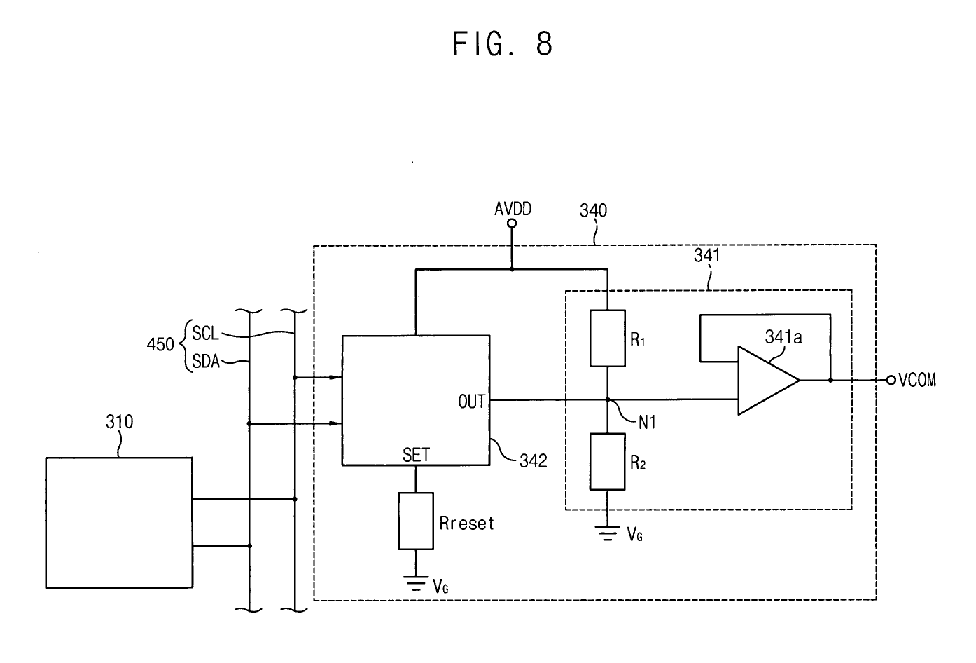

FIG. 8 is a block diagram showing the common voltage generating circuit 340 of FIG. 1.

Referring to FIG. 8, the common voltage generating circuit 340 has a converter 341 and a digitally controlled variable resistor 342. The converter 341 converts the third driving voltage AVDD applied from the power generating circuit 350 (see FIG. 1) into the common voltage VCOM. The converter 341 has a buffer 341a. The buffer 341a is electrically connected to a first node N1 between a first resistor R1 and a second resistor R2 that are electrically connected in series between the third driving voltage AVDD and ground voltage VG. Thus, the buffer 341a outputs the common voltage VCOM, which is voltage divided by the first and second resistors R1 and R2.

The digitally controlled variable resistor 342 has an output terminal OUT electrically connected to the first node N1 and a set terminal SET electrically connected to the ground voltage VG through a reset resistor (Rreset). The digitally controlled variable resistor 342 is electrically connected to the timing control circuit 310 by the inner interface 450. In order to control a voltage level of the common voltage VCOM, the digitally controlled variable resistor 342 controls a current flowing through the first node N1 in response to a first digital control signal.

The timing control circuit 310 outputs the first digital control signal based on the initial data of the liquid crystal display panel 100, which is stored in the nonvolatile memory 320. In the present embodiment, the first digital control signal includes data regarding resistors and synchronizing signals so as to control the current flowing through the first node N1. Thus, the common voltage generating circuit 340 may generate the common voltage VCOM having an appropriate voltage level for the liquid crystal display panel 100.

Although not shown in FIG. 8, the common voltage generating circuit 340 may further include a nonvolatile memory component. In response to data stored into the nonvolatile memory component, the common voltage generating circuit 340 may generate the common voltage VCOM having the appropriate voltage level for the liquid crystal display panel 100 without communication with the timing control circuit 310.

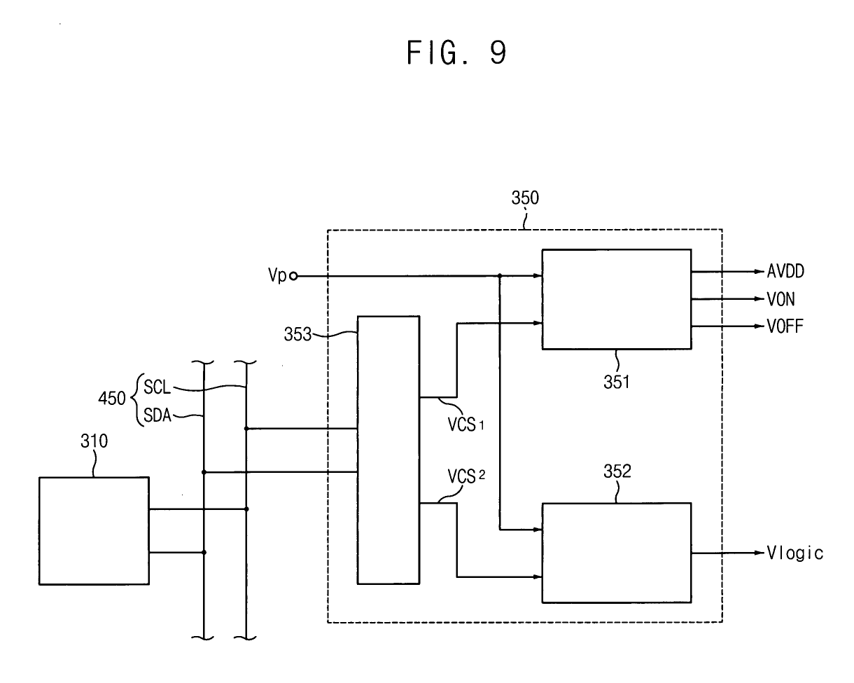

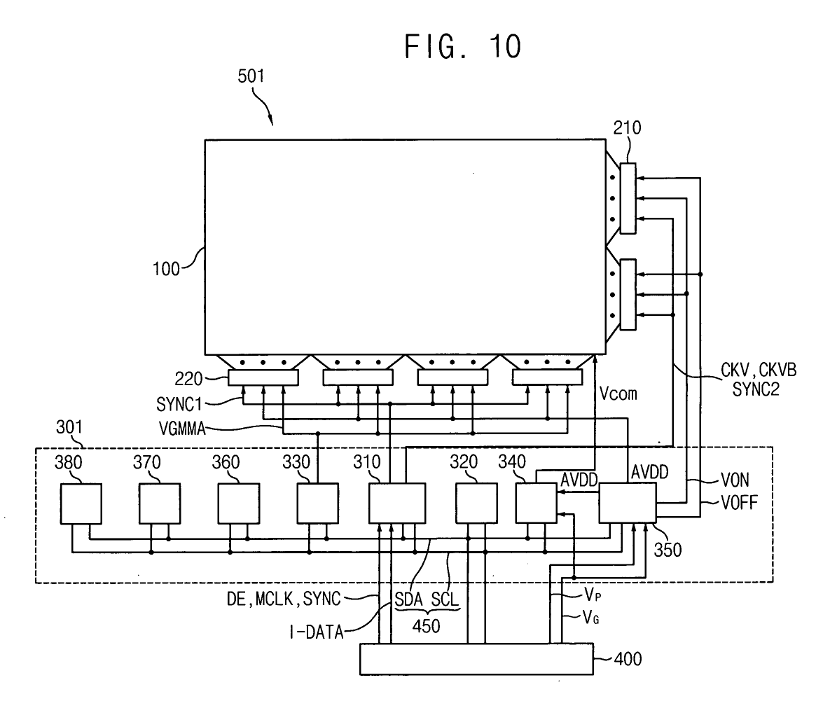

FIG. 9 is a block diagram showing the power generating circuit 350 of FIG. 1.

Referring to FIG. 9, the power generating circuit 350 includes a first voltage generator 351, a second voltage generator 352 and an interface 353.

The interface 353 is electrically connected to the timing control circuit 310 through the inner interface 450. The timing control circuit 310 outputs a second digital control signal based on the initial data of the liquid crystal display panel 100, which is stored in the nonvolatile memory 320. The interface 353 converts the second digital control signal into first and second voltage control signals VCS1 and VCS2 applied to the first and second voltage generators 351 and 352, respectively.

Responsive to the first voltage control signal VCS1, the first voltage generator 351 converts the external power voltage VP into the first driving voltage VON, the second driving voltage VOFF and the third driving voltage AVDD. The first and second driving voltages VON and VOFF from the first voltage generator 351 are applied to the gate driving circuit 210, and the third driving voltage AVDD is applied to the data driving circuit 220. The second voltage generator 352 converts the external power voltage VP into the logic voltage in response to the second voltage control signal VCS2. The logic voltage is applied to circuits of the controller 300 to drive the circuits.

As described above, the voltage level of the first, second and third driving voltages VON, VOFF and AVDD and the logic voltage may be adjusted in accordance with a specification of the liquid crystal display apparatus 500, so that the gate driving circuit 210, the data driving circuit 220 and the circuits of the controller 300 may be operated in response to a voltage having an optimum voltage level.

FIG. 10 is a block diagram showing a liquid crystal display apparatus according to another exemplary embodiment of the present invention. In FIG. 10, the same reference numerals denote the same elements as in FIG. 1, and thus a detailed description of the same elements will be omitted.

Referring to FIG. 10, a controller 301 of a liquid crystal display apparatus 501 according to another exemplary embodiment of the present invention further includes a temperature sensing circuit 360, a brightness sensing circuit 370 and an inverter control circuit 380. The temperature sensing circuit 360, the brightness sensing circuit 370 and the inverter control circuit 380 are electrically connected to the inner interface 450. In the present embodiment, the inverter control circuit 380 may be operated as a master of the inner interface 450 in lieu of the timing control circuit 310.

In general, liquid crystal has various properties such as a response speed, a transmittance and a capacitance that vary according to temperature. The temperature sensing circuit 360 senses an ambient temperature of the liquid crystal display apparatus 501. The temperature sensing circuit 360 converts the sensed ambient temperature into digital temperature data and provides the timing control circuit 310 with the digital temperature data through the inner interface 450. The timing control circuit 310 provides the common voltage generating circuit 340 with the first digital control signal through the inner interface 450 so as to allow the voltage level of the common voltage VCOM to be varied in accordance with the digital temperature data.

Thus, although the ambient temperature of the liquid crystal display apparatus 501 varies, the liquid crystal display apparatus 501 may have an optimal response speed, transmittance and capacitance.

As shown in FIG. 7, the DCC block “DB” of the timing control circuit 310 compensates the response speed of the liquid crystal, and thus the look-up table 311c of the DCC block “DB” may store compensation data suitable for compensating for changes in the ambient temperature. The timing control circuit 310 may vary the compensation data stored into the look-up table 311c according to the digital temperature data from the temperature sensing circuit 360. Thus, although the ambient temperature of the liquid crystal display apparatus 501 varies, the liquid crystal display apparatus 501 may have the optimal response speed.

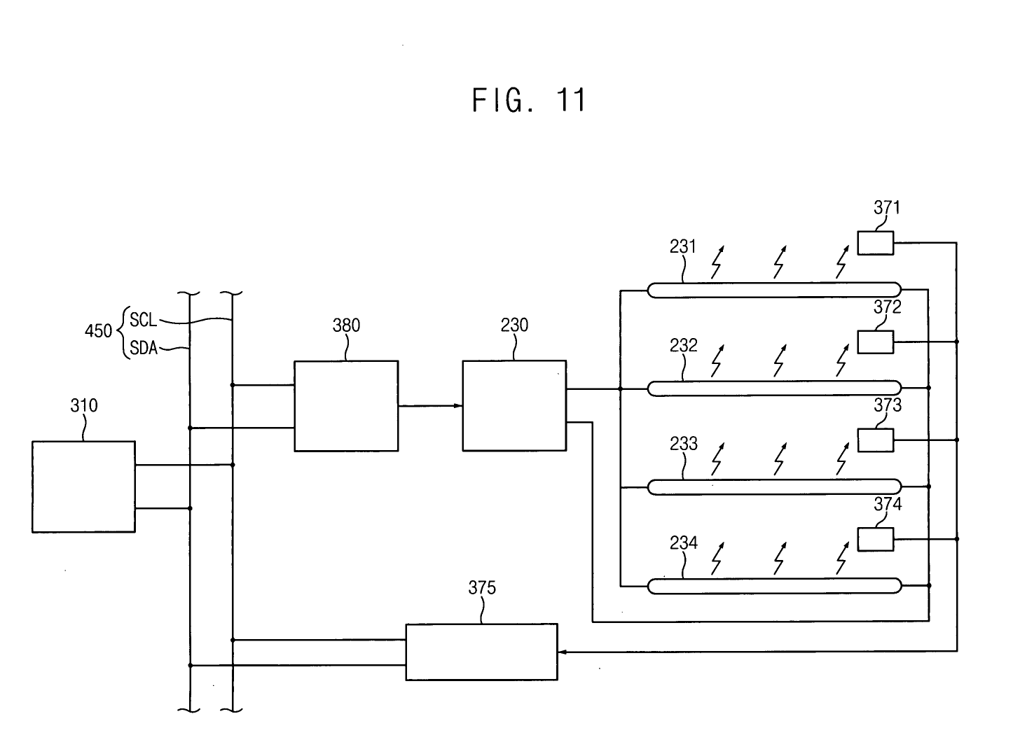

The brightness sensing circuit 370 and the inverter control circuit 380 will be described in detail with reference to FIG. 11.

FIG. 11 is a schematic view showing the inverter control circuit 380 and the brightness sensing circuit 370 of FIG. 10.

Referring to FIG. 11, the liquid crystal display apparatus 501 includes first, second, third and fourth lamps 231, 232, 233 and 234 to supply light to the liquid crystal display panel 100 (see FIG. 10). Each of the first, second, third and fourth lamps 231, 232, 233 and 234 emits light in response to first and second lamp driving voltages. An inverter 230 applies the first and second lamp driving voltages to each of the first, second, third and fourth lamps 231, 232, 233 and 234.

The brightness sensing circuit 370 includes first, second, third and fourth sensors 371, 372, 373 and 374 and a processor 375. The first, second, third and fourth sensors 371, 372, 373 and 374 sense a brightness of light emitted by the first, second, third and fourth lamps 231, 232, 233 and 234, respectively. The processor 375 converts the brightness sensed by the first, second, third and fourth sensors 371, 372, 373 and 374 into digital data. The digital data converted by the processor 375 is applied to the timing control circuit 310 through the inner interface 450.

The timing control circuit 310 provides a comparison between the brightness of light emitted by the first, second, third and fourth lamps 231, 232, 233 and 234 and a predetermined brightness level in response to the digital data. In accordance with a result of the comparison, the timing control circuit 310 transmits a third digital control signal which adjusts voltage levels of the first and second lamp driving voltages.

In response to the brightness of light emitted by the first, second, third and fourth lamps 231, 232, 233 and 234 being lower than the predetermined brightness level, the inverter control circuit 380 enhances a voltage difference between the first and second lamp driving voltages from the inverter 230 responsive to the third digital control signal. Thus, the brightness of light emitted by the first, second, third and fourth lamps 231, 232, 233 and 234 may be enhanced to the predetermined brightness level. On the contrary, in response to the brightness of light emitted by the first, second, third and fourth lamps 231, 232, 233 and 234 being higher than the predetermined brightness level, the inverter control circuit 380 reduces the voltage difference between the first and second lamp driving voltages from the inverter 230 responsive to the third digital control signal. Thus, the brightness of light emitted by the first, second, third and fourth lamps 231, 232, 233 and 234 may be reduced to the predetermined brightness level.

Consequently, the liquid crystal display apparatus 501 may have an enhanced uniform brightness and improved display characteristics.

According to the exemplary embodiments of the display apparatus, circuits of the controller are electrically connected to a digital interface for data communication, so that the circuits of the controller may generate flexible data because a master connected to the digital interface controls the circuits of the controller. Thus, the circuits of the controller may be operated for the flexible data without mechanical operation or replacement, to thereby improve productivity of the display apparatus.

Although the exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is claimed is:

1. A display apparatus comprising:
a display part configured to display images in response to driving signals;
a driving part configured to output the driving signals to the display part in response to control signals;
a control part having circuits to output the control signals to the driving part; and
an interface electrically connected between the circuits of the control part to communicate data between the circuits.

2. The display apparatus of claim 1, wherein the interface is a serial digital interface.

3. The display apparatus of claim 2, wherein the interface is a bi-directional inter-integrated circuit interface.

4. The display apparatus of claim 3, wherein the inter-integrated circuit interface comprises:
a serial data line through which data is transmitted; and
a serial clock line to control a timing of data communication between the circuits.

5. The display apparatus of claim 1, wherein the interface is a parallel digital interface.

6. The display apparatus of claim 1, wherein the control part comprises:
a common voltage generating circuit electrically connected to the interface, the common voltage generating circuit adjusting a voltage level of a common voltage and outputting the common voltage in response to a digital control signal; and
a timing control circuit electrically connected to the interface, the timing control circuit providing image data and the control signals to the driving part in response to an external signal.

7. The display apparatus of claim 6, wherein the timing control circuit acts as a master and outputs the digital control signal to the interface, and wherein the common voltage generating circuit acts as a slave of the timing control circuit and receives the digital control signal.

8. The display apparatus of claim 7, wherein the timing control circuit comprises:
a data block to process the image data;
a control signal block to generate the control signals provided to the driving part using an external synchronizing signal; and
an interface block receptive of both data and a synchronizing signal inputted via the interface, the interface block providing received data and the synchronizing signal to the circuits of the control part via the interface.

9. The display apparatus of claim 8, wherein the driving part comprises:
a data driving part configured to output a data signal of the driving signals in response to the image data and a data control signal of the control signals; and
a gate driving part configured to output a gate signal of the driving signals in response to a gate control signal of the control signals.

10. The display apparatus of claim 8, wherein the data block comprises:
an accurate color capture block to increase bit numbers of the image data; and
a dynamic capacitance compensation block to adjust a gray-scale value of the image data.

11. The display apparatus of claim 6, wherein the control part further comprises a nonvolatile memory storing initial data having information relating to a characteristic of the display part, and
the timing control circuit generates the digital control signal based on the initial data such that the common voltage generating circuit generates the common voltage for the display part.

12. The display apparatus of claim 11, wherein the common voltage generating circuit comprises:
a converting part to convert an external voltage into the common voltage; and
a digitally controlled variable resistance part to adjust the voltage level of the common voltage in response to the digital control signal.

13. The display apparatus of claim 12, wherein the converting part comprises:
first and second resistors connected in series between the external voltage and a ground voltage to produce a divided external voltage; and
a buffer to output the common voltage responsive to the divided external voltage.

14. The display apparatus of claim 1, wherein the control part comprises:
a gamma voltage generating circuit electrically connected to the interface, the gamma voltage generating circuit changing gamma data into a gamma voltage in an analog form; and
a timing control circuit electrically connected to the interface, the timing control circuit applying image data and the control signals in response to an external signal.

15. The display apparatus of claim 14, wherein the control part further comprises:
a nonvolatile memory storing initial data having information relating to a characteristic of the display part, the nonvolatile memory being electrically connected to the interface; and
a frame memory to repeatedly store the image data frame by frame.

16. The display apparatus of claim 14, wherein the timing control circuit receives the gamma data corresponding to one frame from the nonvolatile memory to calculate an average brightness of the display part responsive to the one frame, and the timing control circuit outputs the gamma data to the gamma voltage generating circuit.

17. The display apparatus of claim 14, wherein the control part further comprises:
a common voltage generating circuit electrically connected to the interface, the common voltage generating circuit adjusting a voltage level of a common voltage and outputting the common voltage in response to a first digital control signal; and
a power voltage generating circuit electrically connected to the interface, the power voltage generating circuit outputting a power voltage as a driving voltage and a logic voltage in response to a second digital control signal.

18. The display apparatus of claim 17, wherein the power voltage generating circuit comprises:
an interface part electrically connected to the interface, the interface part changing the second digital control signal into a first control signal and a second control signal;
a driving voltage generating part to change the external voltage into the driving voltage for the driving part in response to the first control signal; and
a logic voltage generating part to change the external voltage into the logic voltage for the circuits of the control part in response to the second control signal.

19. The display apparatus of claim 17, wherein the control part senses an ambient temperature and provides digital temperature data to the timing control circuit via the interface, the digital temperature data being responsive to the ambient temperature sensed by the control part.

20. The display apparatus of claim 19, wherein the timing control circuit, responsive to the digital temperature data, provides the first digital control signal to the common voltage generating circuit via the interface such that the voltage level of the common voltage is adjusted.

21. The display apparatus of claim 14, further comprising:
an inverter to output a first lamp driving voltage and a second lamp driving voltage; and
a light emitting part including a lamp emitting light in response to the first and lo second lamp driving voltages to provide the light to the display part.

22. The display apparatus of claim 21, wherein the control part further comprises:
a brightness sensing circuit configured to:
sense a brightness of the light emitted by the light emitting part;
change the brightness sensed into a digital value; and
provide the digital value to the timing control circuit via the interface; and
an inverter control circuit to receive a third digital control signal from the timing control circuit and adjust voltage levels of the first and second lamp driving voltages, the third digital control signal being responsive to the digital value.

23. The display apparatus of claim 22, wherein the inverter control circuit controls the inverter such that a difference between the first and second lamp driving voltage increases when the brightness sensed is lower than a predetermined reference brightness level, and
the inverter control circuit controls the inverter such that the difference between the first and second lamp driving voltages decreases when the brightness sensed is higher than the predetermined reference brightness level.

24. A display apparatus comprising:
a display panel having a data line receiving a data signal and a gate line receiving a gate signal to display images in response to the data signal and the gate signal;
a data driving circuit to output the data signal to the data line in response to an image data and a data control signal;
a gate driving circuit to output the gate signal to the gate line in response to a gate control signal;
a common voltage generating circuit to adjust a voltage level of a common voltage and apply the common voltage to the display panel in response to a first digital control signal;
a gamma voltage generating circuit to convert a gamma data into a gamma voltage in an analog form and apply the gamma voltage to the data driving circuit;
a timing control circuit, responsive to an external signal, to apply the gate control signal to the gate driving circuit, apply the image data and the data control signal to the data driving circuit and output the first digital control signal and the gamma data; and
an interface electrically connected to the common voltage generating circuit, the gamma voltage generating circuit and the timing control circuit to communicate data between the common voltage generating circuit, the gamma voltage generating circuit and the timing control circuit.

25. The display apparatus of claim 24, further comprising:
a nonvolatile memory to store initial data having information relating to the display panel and the gamma data and to communicate data with the timing control circuit via the interface; and
a power voltage generating circuit to receive a second digital control signal from the timing control circuit via the interface, and to change a power voltage into a driving voltage and a logic voltage in response to the second digital control signal and output the driving voltage and the logic voltage.

26. The display apparatus of claim 24, wherein the common voltage generating circuit is configured to vary the voltage level of the common voltage responsive to at least one of:
an ambient temperature of the display apparatus; and
a brightness of the display apparatus.
